(19) United States
(12) Patent Application Publication
(10) Pub. No.: US 2024/0279435 A1
(43) Pub. Date: Aug. 22, 2024

(54) Polymeric Compositions That Reduce Die Buildup During Extrusion and Related Methods

(71) Applicant: Dover Chemical Corporation, Dover, OH (US)

(72) Inventors: Michael Jakupca, Canton, OH (US); Shawn Cook, Canton, OH (US); John Regula, Baltic, OH (US); Quinn Braun, Akron, OH (US)

(73) Assignee: Dover Chemical Corporation, Dover, OH (US)

(21) Appl. No.: 18/413,814

(22) Filed: Jan. 16, 2024

Related U.S. Application Data
(60) Provisional application No. 63/439,041, filed on Jan. 13, 2023.

(51) Int. Cl. C08K 5/526; B29C 48/00; B29K 23/00; B29K 105/00; C08K 3/26; C08K 5/524; C08L 23/06

(52) U.S. Cl. CPC C08K 5/526; B29C 48/022; C08K 3/26; C08K 5/524; C08L 23/06; B29K 2023/00; B29K 2023/0625; B29K 2105/0088; C08K 2003/265; C08L 2207/066

(57) ABSTRACT

A manufacturing process comprising the steps: compounding a composition having: a polyolefin, a first component that is a polyethylene glycol, a polyethylene glycol mono-ester, or a polyethylene glycol di-ester, and a second component that is a phosphorus-containing compound having one of the following two structures:

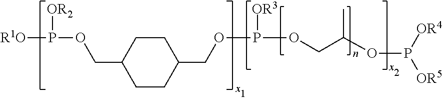

wherein each R¹, R², R³, R⁴ and R⁵ is independently selected and is a C₁₀-C₁₈ alkyl moiety; n is an integer ranging from 3-11; and the sum of x₁+x₂ is an integer ranging from 1-251, or

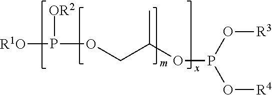

wherein each R¹, R², R³ and R⁴ is independently selected and is a C₁₀-C₁₈ alkyl moiety; m is an integer ranging from 3-11; and x is an integer ranging from 1-122, wherein the composition does not include a fluorine-containing compound; and extruding the compounded composition through a die, and wherein the manufacturing process has a reduced rate of die buildup relative to a manufacturing process that is otherwise the same but does not include the first component or the second component.

### CROSS REFERENCE TO RELATED APPLICATIONS

This patent application claims priority to U.S. provisional patent application Ser. No. 63/439,041 having a filing date of Jan. 13, 2023. The subject matter of U.S. provisional patent application Ser. No. 63/439,041 having a filing date of Jan. 13, 2023 is incorporated by reference into this application.

### BACKGROUND OF THE INVENTION

In polymeric-extrusion processing, there remains a need to eliminate or reduce the rate of accumulation of unwanted material on a heated die, i.e., to eliminate or reduce the rate of unwanted die buildup on a heated die. Die buildup can detrimentally impact the quality of the extrudate (i.e., the composition being extruded from the heated die) because portions of accumulated die buildup can break free or flake off from the heated die and appear in the extrudate as black specs or some other kind of contamination. Contamination resulting from die-buildup often leads to extrudate or extruded products, such as extruded polymeric films, that fail to meet quality standards. This, of course, leads to manufacturing inefficiencies.

As a result of an extrusion process's rate of die buildup, manufacturing processes must be periodically shut down for a maintenance time period that is at least equal to the time that it takes to clean die buildup off of a heated die. These periods of time, in which manufacturing is not taking place, result in the loss of productive manufacturing—which in turn results in additional manufacturing costs.

### BRIEF SUMMARY OF THE INVENTION

A manufacturing process comprising the steps: compounding a composition having: a polyolefin, a first component that is a polyethylene glycol, a polyethylene glycol mono-ester, or a polyethylene glycol di-ester, and a second component that is a phosphorus-containing compound having one of the following two structures:

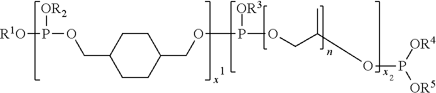

wherein each R¹, R², R³, R⁴ and R⁵ is independently selected and is a C₁₀-C₁₈ alkyl moiety; n is an integer ranging from 3-11; and the sum of x₁+x₂ is an integer ranging from 1-251, or

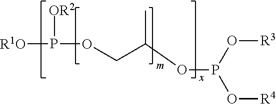

wherein each R¹, R², R³ and R⁴ is independently selected and is a C₁₀-C₁₈ alkyl moiety; m is an integer ranging from 3-11; and x is an integer ranging from 1-122, wherein the composition does not include a fluorine-containing compound; and extruding the compounded composition through a die, and wherein the manufacturing process has a reduced rate of die buildup relative to a manufacturing process that is otherwise the same but does not include the first component or the second component.

A manufacturing process comprising the steps: compounding a composition having: a polyolefin, a first component that is a polycaprolactone, and a second component that is a phosphorus-containing compound having one of the following two structures:

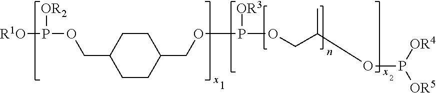

wherein each R¹, R², R³, R⁴ and R⁵ is independently selected and is a C₁₀-C₁₈ alkyl moiety; n is an integer ranging from 3-11; and the sum of x₁+x₂ is an integer ranging from 1-251, or

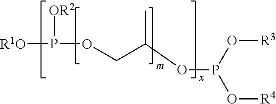

wherein each R¹, R², R³ and R⁴ is independently selected and is a C₁₀-C₁₈ alkyl moiety; m is an integer ranging from 3-11; and x is an integer ranging from 1-122, wherein the composition does not include a fluorine-containing compound; and extruding the compounded composition through a die, and wherein the manufacturing process has a reduced rate of die buildup relative to a manufacturing process that is otherwise the same but does not include the first component or the second component.

A manufacturing process comprising the steps: compounding a composition having: a polyolefin, a first component that is a polypropylene glycol, a polypropylene glycol mono-ester, or a polypropylene glycol di-ester, and a second component that is a phosphorus-containing compound having one of the following two structures:

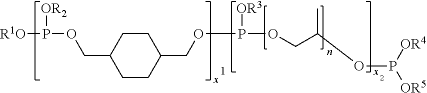

wherein each R¹, R², R³, R⁴ and R⁵ is independently selected and is a C₁₀-C₁₈ alkyl moiety; n is an integer ranging from 3-11; and the sum of x₁+x₂ is an integer ranging from 1-251, or

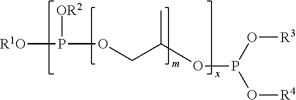

wherein each R¹, R², R³ and R⁴ is independently selected and is a C₁₀-C₁₈ alkyl moiety; m is an integer ranging from 3-11; and x is an integer ranging from 1-122, wherein the composition does not include a fluorine-containing compound; and extruding the compounded composition through a die, and wherein the manufacturing process has a reduced rate of die buildup relative to a manufacturing process that is otherwise the same but does not include the first component or the second component.

A manufacturing process comprising the steps: compounding a composition having: a polyolefin, a first component that is a polyethylene glycol-polypropylene glycol copolymer, a polyethylene glycol-polycaprolactone copolymer, a polypropylene glycol-polycaprolactone copolymer, or a 1,4 butanediol glycol-polycaprolactone copolymer, and a second component that is a phosphorus-containing compound having one of the following two structures:

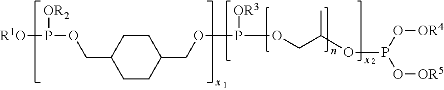

wherein each R¹, R², R³, R⁴ and R⁵ is independently selected and is a C₁₀-C₁₈ alkyl moiety; n is an integer ranging from 3-11; and the sum of x₁+x₂ is an integer ranging from 1-251, or

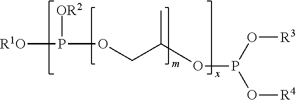

wherein each R¹, R², R³ and R⁴ is independently selected and is a C₁₀-C₁₈ alkyl moiety; m is an integer ranging from 3-11; and x is an integer ranging from 1-122, wherein the composition does not include a fluorine-containing compound; and extruding the compounded composition through a die, and wherein the manufacturing process has a reduced rate of die buildup relative to a manufacturing process that is otherwise the same but does not include the first component or the second component.

A manufacturing process comprising the steps: compounding a composition having: a polyolefin, a first component that is an ester prepared from a copolymer of polyethylene glycol and polypropylene glycol, and a second component that is a phosphorus-containing compound having one of the following two structures:

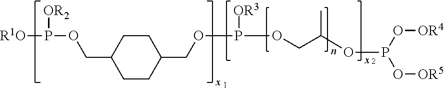

wherein each R¹, R², R³, R⁴ and R⁵ is independently selected and is a C₁₀-C₁₈ alkyl moiety; n is an integer ranging from 3-11; and the sum of x₁+x₂ is an integer ranging from 1-251, or

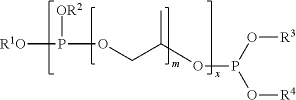

wherein each R¹, R², R³ and R⁴ is independently selected and is a C₁₀-C₁₈ alkyl moiety; m is an integer ranging from 3-11; and x is an integer ranging from 1-122, wherein the composition does not include a fluorine-containing compound; and extruding the compounded composition through a die, and wherein the manufacturing process has a reduced rate of die buildup relative to a manufacturing process that is otherwise the same but does not include the first component or the second component.

### BRIEF DESCRIPTION OF THE SEVERAL VIEWS OF THE DRAWING(S)

The patent or application file contains at least one drawing executed in color. Copies of this patent or patent application publication with color drawing(s) will be provided by the Office upon request and payment of the necessary fee.

FIG. 1 shows color photographs of film die buildup resulting from using Formulations A-G described in the Experimental section of this application.

FIG. 2A shows color photographs of stand die buildup resulting from using Formulation A described in the Experimental section of this application.

FIG. 2B shows color photographs of stand die buildup resulting from using Formulation B described in the Experimental section of this application.

FIG. 2C shows color photographs of stand die buildup resulting from using Formulation C described in the Experimental section of this application.

FIG. 2D shows color photographs of stand die buildup resulting from using Formulation D described in the Experimental section of this application.

### DETAILED DESCRIPTION OF THE INVENTION

Embodiments are generally directed to polymeric-extrusion manufacturing methods employing non-fluorinated polymeric processing aids that result in the manufacturing embodiments having a reduced rate of die buildup relative to manufacturing methods that are otherwise the same but do not employ the non-fluorinated polymeric processing aids.

Very generally, embodiments are directed to manufacturing methods that employ non-fluorinated polymeric processing aids in compositions having: a polyolefin, a first component, and a second component.

Regarding chemical nomenclature used herein, copolymers, in many instances are referred to using a hyphen, i.e., a “-” character, to identify the distinction between a first copolymeric unit and a second copolymeric unit. For example, an A-B copolymer indicates that “A” refers to the first copolymeric unit and “B” is the second copolymeric unit. Furthermore, within the chemical structures herein that depict copolymers, “Aₙ-Bₘ” indicates that the first repeating copolymeric unit “A” is repeated “n” times and the second repeating copolymeric unit “B” is repeated “m” times. Still further regarding the structures that depict copolymers, repeating copolymeric units that are within a parenthetical (versus brackets) should be understood to teach both the block copolymer embodiment(s) and the random copolymer embodiment(s). For example, in the following illustrative copolymeric structure:

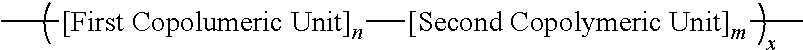

wherein
   n is an integer ranging from 1-10;
   m is an integer ranging from 1-10; and
   x is an integer ranging from 1-1000,
      it should be understood that when x is >1, the parenthetical units that x is referring to may be the same or different. When they are the same, a block copolymer results, and when different, a random copolymer results.

Polymeric-extrusion manufacturing methods that include the step of extruding polymeric compositions through a heated die are well known. Persons of ordinary skill in the art are able to determine useful die temperatures without having to exercise undue experimentation. As a nonlimiting example, useful compounding and extrusion temperatures for manufacturing blown polymeric films can be determined by persons having ordinary skill in the art without having to exercise undue experimentation. In embodiments, useful blown-film manufacturing temperatures range from 190° C. to 250° C.; in other embodiments, temperatures of around 220° C. are useful for manufacturing blown films. Useful temperatures for manufacturing cast films can also be determined by persons having ordinary skill in the art without having to exercise undue experimentation. In embodiments, useful cast-film manufacturing temperatures typically range from 250° C. to 330° C. In other embodiments, useful cast-film manufacturing temperatures typically range from 240° C. to 330° C.

All polyolefins known to be useful for manufacturing cast and blown films can be employed in the embodiments. In particular embodiments, useful polyolefins include: polyethylene (PE), linear low-density polyethylene (LLDPE), low-density polyethylene (LDPE), high-density polyethylene (HDPE), polypropylene (PP), and combinations thereof.

In embodiments, the first component is a polyethylene glycol, a polyethylene glycol mono-ester, or a polyethylene glycol di-ester. In embodiments, the polyethylene glycol has the structure:

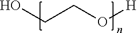

wherein
   n is an integer ranging from 3-500.

In embodiments, polyethylene glycol in the range of 1000 g/mol (n being approximately 23) to 10,000 g/mol (n being approximately 227) are useful.

In embodiments, the polyethylene glycol mono-ester has the structure:

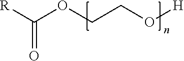

wherein
   n is an integer ranging from 3-500, and
   R is a C₁-C₂₈ saturated or unsaturated moiety.

Useful embodiments also include polyethylene glycol mono-esters having the structure:

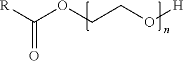

wherein
n is an integer ranging from 3-500, and
R is a C₆-C₂₀ saturated or unsaturated moiety.

In embodiments, the polyethylene glycol di-ester has the structure:

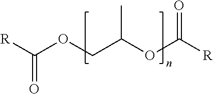

wherein
   n is an integer ranging from 3-500, and
   each R is independently selected and is a C₁-C₂₈ saturated or unsaturated moiety.

In other embodiments, the first component is a polycaprolactone. In embodiments, the polycaprolactone has the structure:

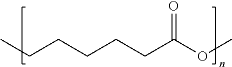

wherein
   n is an integer ranging from 3-500.

In other embodiments, the first component is a polypropylene glycol, a polypropylene glycol mono-ester, or a polypropylene glycol di-ester. In embodiments, the polypropylene glycol has the structure:

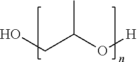

wherein
   n is an integer ranging from 3-500;
      the polypropylene glycol mono-ester has the structure:

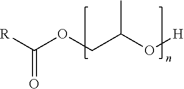

wherein
   n is an integer ranging from 3-500, and
   R is a C₁-C₂₈ saturated or unsaturated moiety; and
      the polypropylene glycol di-ester has the structure:

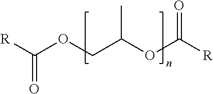

wherein
   n is an integer ranging from 3-500, and
   each R is independently selected and is a C₁-C₂₈ saturated or unsaturated moiety.

In other embodiments, the first component is a polyethylene glycol-polypropylene glycol copolymer. In embodiments, the polyethylene glycol-polypropylene glycol copolymer has the structure:

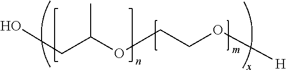

wherein
   n is an integer ranging from 1-500,
   m is an integer ranging from 1-500, and
   x is an integer ranging from 1-500.

In still other embodiments, the first component is an ester prepared from a copolymer of polyethylene glycol and polypropylene glycol. In embodiments, the ester prepared from a copolymer of polyethylene glycol and polypropylene glycol has one of the following two structures:

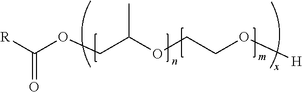

wherein
   n is an integer ranging from 1-500,
   m is an integer ranging from 1-500,
   x is an integer ranging from 1-500, and
   R is a C₁-C₂₈ saturated or unsaturated moiety
or

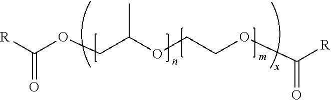

wherein
   n is an integer ranging from 1-500,
   m is an integer ranging from 1-500,
   x is an integer ranging from 1-500, and
   each R is independently selected from a C₁-C₂₈ saturated or unsaturated moiety.

In still other embodiments, the first component is: (i) a polyethylene glycol-polycaprolactone copolymer, or (ii) a polypropylene glycol-polycaprolactone copolymer. In those embodiments in which the first component is a polyethylene glycol-polycaprolactone copolymer, the polyethylene glycol-polycaprolactone copolymer has one of the following three structures:

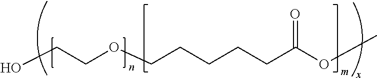

wherein
   n is an integer ranging from 1-500,
   m is an integer ranging from 1-500, and
   x is an integer ranging from 1-500;
      or

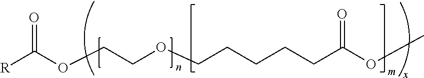

wherein
   n is an integer ranging from 1-500,
   m is an integer ranging from 1-500,
   x is an integer ranging from 1-500, and
   R is a C₁-C₂₈ saturated or unsaturated moiety;
      or

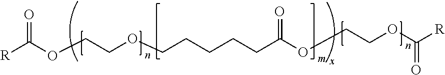

wherein
   n is an integer ranging from 1-500,
   m is an integer ranging from 1-500,
   x is an integer ranging from 1-500, and
   each R is independently selected from a C₁-C₂₈ saturated or unsaturated moiety.

And in those embodiments in which the first component is a polypropylene glycol-polycaprolactone copolymer, the polypropylene glycol-polycaprolactone copolymer has one of the following three structures:

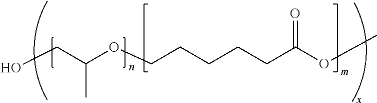

wherein
   n is an integer ranging from 1-500,
   m is an integer ranging from 1-500, and
   x is an integer ranging from 1-500
      or

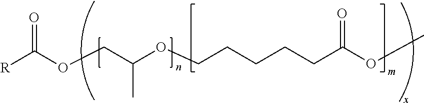

wherein
   n is an integer ranging from 1-500,
   m is an integer ranging from 1-500,
   x is an integer ranging from 1-500, and
   R is a C₁-C₂₈ saturated or unsaturated moiety;
      or

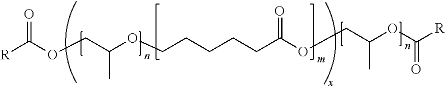

wherein
   n is an integer ranging from 1-500,
   m is an integer ranging from 1-500,
   x is an integer ranging from 1-500, and
   each R is independently selected from a C₁-C₂₈ saturated or unsaturated moiety.

In still other embodiments, the first component is a 1,4 butanediol glycol-polycaprolactone copolymer that has one of the following three structures:

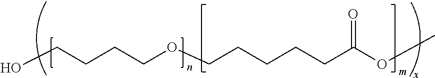

wherein
   n is an integer ranging from 1-500,
   m is an integer ranging from 1-500,
   x is an integer ranging from 1-500
      or

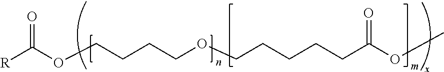

wherein
   n is an integer ranging from 1-500,
   m is an integer ranging from 1-500,
   x is an integer ranging from 1-500, and
   R is a C₁-C₂₈ saturated or unsaturated moiety;
      or

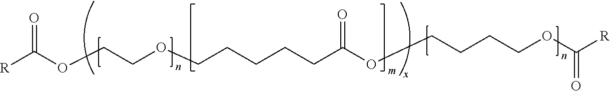

wherein
   n is an integer ranging from 1-500,
   m is an integer ranging from 1-500,
   x is an integer ranging from 1-500, and
   R is a C₁-C₂₈ saturated or unsaturated moiety.

In embodiments the polycaprolactone copolymers can be a diol having both ends of the polymer chain terminated with a hydroxyl moiety.

In embodiments, the first component is in the composition in an amount ranging from 250-5000 parts per million.

In embodiments, the second component is a phosphorus-containing compound having one of the following two structures:

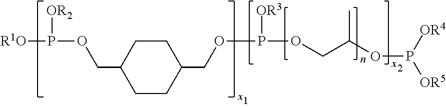

wherein
   each R¹, R², R³, R⁴ and R⁵ is independently selected and is a C₁₀-C₁₈ alkyl moiety;
   n is an integer ranging from 3-11; and
   the sum of x₁+x₂ is an integer ranging from 1-251,
      or

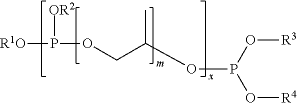

wherein
   each R¹, R², R³ and R⁴ is independently selected and is a C₁₀-C₁₈ alkyl moiety;
   m is an integer ranging from 3-11; and
   x is an integer ranging from 1-122.

The second component can be obtained commercially, or it can be manufactured using a known method.

In embodiments, the second component is in the composition in an amount ranging from 250-5000 parts per million.

Methods for compounding and extruding polymeric compositions are well known, and any of them may be used. Persons having ordinary skill in the art will be able to determine compounding conditions without having to exercise undue experimentation. Non-limiting examples of known compounding methods include: banbury mixing, single-screw compounding, and twin-screw compounding.

All of the embodiments described herein specifically exclude the use of fluorine-containing compounds.

All of the embodiments described herein have a reduced rate of die buildup relative to a manufacturing process that is otherwise the same but does not employ a polymeric composition having the first component or the second component.

To assess a manufacturing method's rate of die buildup, a variety of methods can be used. Nonlimiting examples include: 1) visual inspections of the die (and diebuildup) at regular time intervals (see the figures), 2) taking photographs of the die (and diebuildup) at regular time intervals and then calculating the area of die buildup shown in the photograph through integration, and 3) scraping the die buildup off of the die at regular time intervals and then weighing the scraped-off die buildup. Persons of ordinary skill in the art will be able to calculate a manufacturing method's rate of die buildup without having to exercise undue experimentation.

Any additive or additives known useful for polymer compounding or processing can be used in the disclosed embodiments.

### EXPERIMENTAL

The processing aid packages containing the polymeric phosphites in combination with a lubricant were evaluated under a number of different processing temperatures and conditions and resin grades to show their effectiveness.

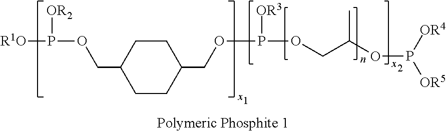

wherein
   each R¹, R², R³, R⁴ and R⁵ is independently selected and is a C₁₀-C₁₈ alkyl moiety;
   n is an integer ranging from 3 to 11; and
   the sum of x₁+x₂ is an integer ranging from 1-251.

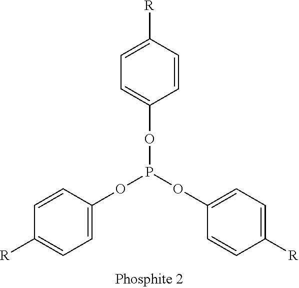

wherein R is a branched or linear nonyl group

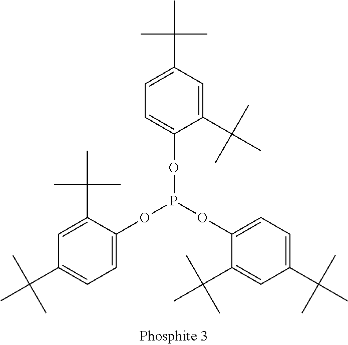 [SMILES: CC(C)(C)c1ccc(OP(Oc2ccc(C(C)(C)C)cc2C(C)(C)C)Oc2ccc(C(C)(C)C)cc2C(C)(C)C)c(C(C)(C)C)c1]

### Example 1 CaCO₃ Filled Film

The processing aid package of the current invention was evaluated to show the synergistic performance of the polymeric phosphite 1 in combination with a 1,4 butanediol glycol-polycaprolactone copolymer having an average molecular weight of 4000 g/mol. The formulations were compounded into a 1MI LLDPE resin using a ¾ inch single screw Brabender extruder. The polymer was extruded through a 2 inch by 0.02 inch film die at 80 rpm and 250 C to produce a 0.02 inch thick film.

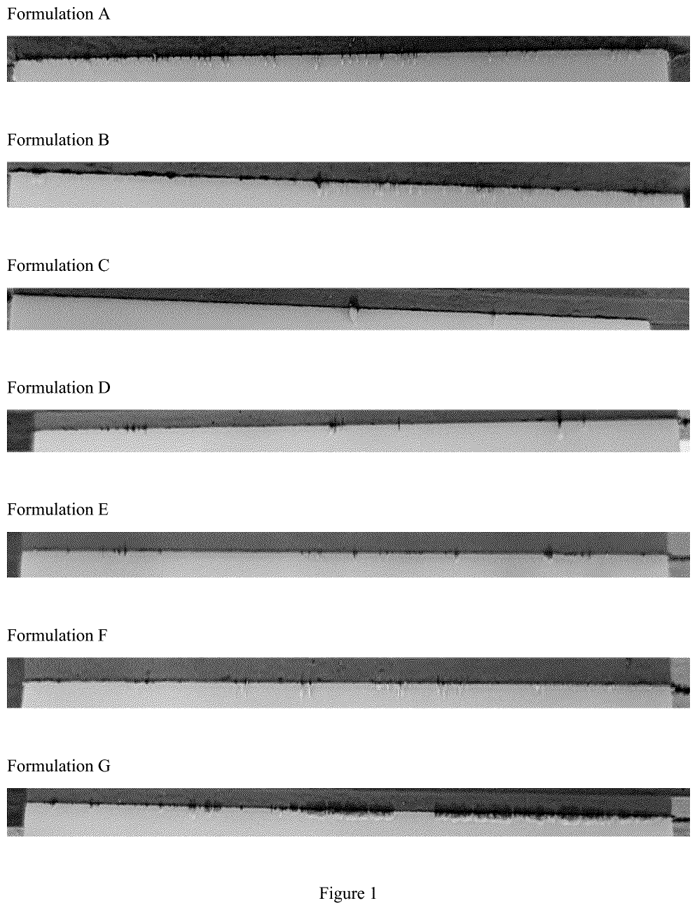

The film die was examined after extruding each formulation for 1 hour and the amount of buildup covering the edge of the die was estimated visually. The formulation containing a combination of the polymeric phosphite 1 and the polycaprolactone copolymer had only a small amount of buildup compared to the other formulations. The addition of phosphite 3 to the formulation containing the polymeric phosphite 1 and the polycaprolactone copolymer increased the amount of die buildup. See FIG. 1.

| Formulation | A | B | C | D | E | F | G |
|---|---|---|---|---|---|---|---|
| 1 MI LLDPE | 80% | 80% | 80% | 80% | 80% | 80% | 80% |
| CaCO₃ | 20% | 20% | 20% | 20% | 20% | 20% | 20% |
| Polymeric Phosphite 1 | | 1600 | 1600 | | | 1600 | |
| Phosphite 2 | | | | | | | 1500 |
| Phosphite 3 | | | | | 1500 | 1500 | |
| Polycaprolactone | | | 800 | | | 800 | |
| co-polymer | | | | | | | |
| Fluoropolymer PPA | | | | 500 | 500 | | |
| % of Die covered | 35 | 25 | 3 | 5 | 15 | 15 | 60 |
| with Buildup | | | | | | | |

### Example 2

The processing aid package of the current invention was evaluated to show the synergistic performance of the polymeric phosphite 1 in combination with a polycaprolactone that was >90% homopolymer with an average molecular weight of 80,000 g/mol when extruded through a different type of die. The formulations were compounded into a 1MI LLDPE resin using a 4-inch single screw Brabender extruder. The polymer was extruded through a dual strand die at 80 rpm and 250 C.

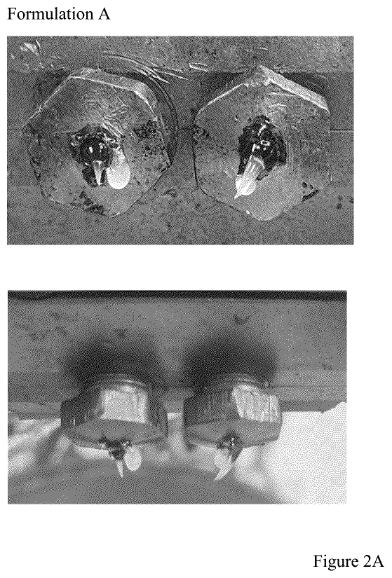

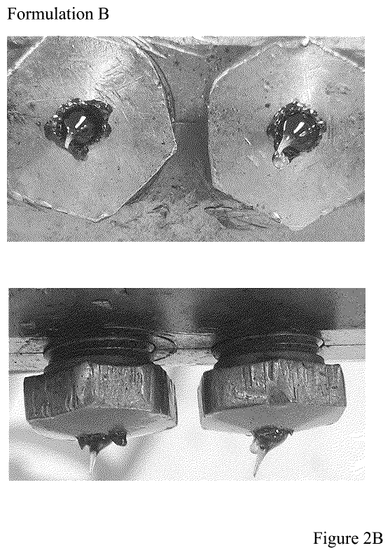

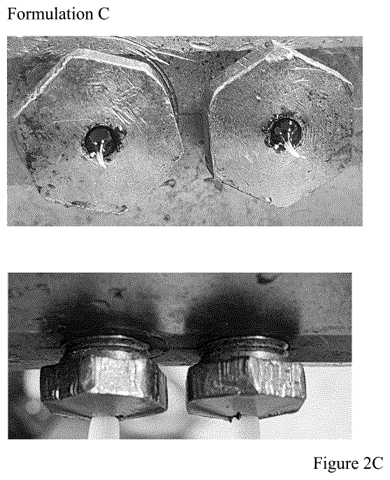

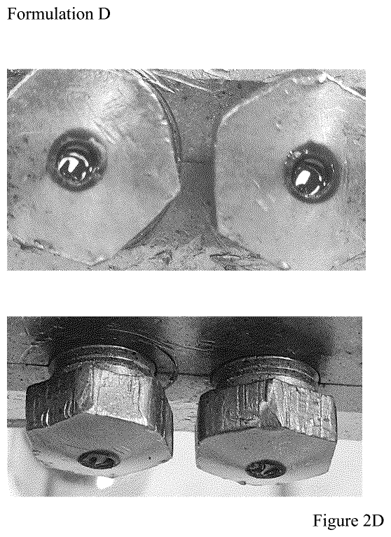

The strand die was examined after extruding each formulation for 1 hour and the amount of buildup covering the edge of the die was estimated visually. The formulation containing a combination of the polymeric phosphite 1 and the polycaprolactone copolymer had no visible buildup compared to the other formulations. See FIGS. 2A-2D.

| Formulation | A | B | C | D |
|---|---|---|---|---|
| 1MI LLDPE | X | X | X | X |
| Phosphite 3 | 1500 | 1500 | 1500 | 1500 |
| Polymeric Phosphite 1 | | 1600 | | 1600 |
| Polycaprolactone | | | 1200 | 1200 |
| % of Die covered with Buildup | >90 | 80 | 5 | 0 |

1. A manufacturing process comprising the steps:
compounding a composition having:
a polyolefin,
a first component that is a polyethylene glycol, a polyethylene glycol mono-ester, or a polyethylene glycol di-ester, and
a second component that is a phosphorus-containing compound having one of the following two structures: 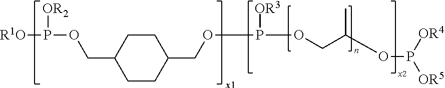
wherein
each R¹, R², R³, R⁴ and R⁵ is independently selected and is a C₁₀-C₁₈ alkyl moiety;
n is an integer ranging from 3-11; and
the sum of x₁+x₂ is an integer ranging from 1-251,
or 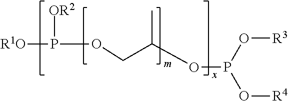
wherein
each R¹, R², R³ and R⁴ is independently selected and is a C₁₀-C₁₈ alkyl moiety;
m is an integer ranging from 3-11; and
x is an integer ranging from 1-122,
wherein the composition does not include a fluorine-containing compound; and
extruding the compounded composition through a die, and
wherein the manufacturing process has a reduced rate of die buildup relative to a manufacturing process that is otherwise the same but does not include the first component or the second component.

2. The manufacturing process of claim 1, wherein the polyethylene glycol has the structure: 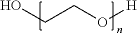
wherein
n is an integer ranging from 3-500;
the polyethylene glycol mono-ester has the structure: 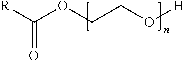
wherein
n is an integer ranging from 3-500, and
R is a C₁-C₂₈ saturated or unsaturated moiety; and
the polyethylene glycol di-ester has the structure: 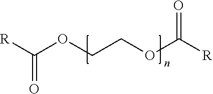
wherein
n is an integer ranging from 3-500, and
each R is independently selected and is a C₁-C₂₈ saturated or unsaturated moiety.

3. The manufacturing process of claim 1, wherein the first component is in the composition in an amount ranging from 250-5000 parts per million, and
the second component is in the composition in an amount ranging from 250-5000 parts per million.

4. A manufacturing process comprising the steps:
compounding a composition having:
a polyolefin,
a first component that is a polycaprolactone, and
a second component that is a phosphorus-containing compound having one of the following two structures: 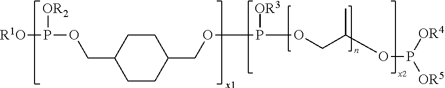
wherein
each R¹, R², R³, R⁴ and R⁵ is independently selected and is a C₁₀-C₁₈ alkyl moiety;
n is an integer ranging from 3-11; and
the sum of x₁+x₂ is an integer ranging from 1-251,
or 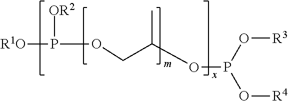
wherein
each R¹, R², R³ and R⁴ is independently selected and is a C₁₀-C₁₈ alkyl moiety;
m is an integer ranging from 3-11; and
x is an integer ranging from 1-122,
wherein the composition does not include a fluorine-containing compound; and
extruding the compounded composition through a die, and
wherein the manufacturing process has a reduced rate of die buildup relative to a manufacturing process that is otherwise the same but does not include the first component or the second component.

5. The manufacturing process of claim 4, wherein the polycaprolactone has the structure: 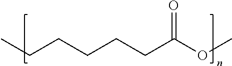
wherein
n is an integer ranging from 3-500.

6. The manufacturing process of claim 4, wherein the first component is in the composition in an amount ranging from 250-5000 parts per million, and
the second component is in the composition in an amount ranging from 250-5000 parts per million.

7. A manufacturing process comprising the steps:
compounding a composition having:
a polyolefin,
a first component that is a polypropylene glycol, a polypropylene glycol mono-ester, or a polypropylene glycol di-ester, and
a second component that is a phosphorus-containing compound having one of the following two structures: 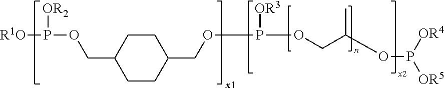
wherein
each R¹, R², R³, R⁴ and R⁵ is independently selected and is a C₁₀-C₁₈ alkyl moiety;
n is an integer ranging from 3-11; and
the sum of x₁+x₂ is an integer ranging from 1-251,
or 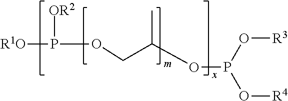
wherein
each R¹, R², R³ and R⁴ is independently selected and is a C₁₀-C₁₈ alkyl moiety;
m is an integer ranging from 3-11; and
x is an integer ranging from 1-122,
wherein the composition does not include a fluorine-containing compound; and
extruding the compounded composition through a die, and
wherein the manufacturing process has a reduced rate of die buildup relative to a manufacturing process that is otherwise the same but does not include the first component or the second component.

8. The manufacturing process of claim 7, wherein the polypropylene glycol has the structure: 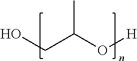
wherein
n is an integer ranging from 3-500;
the polypropylene glycol mono-ester has the structure: 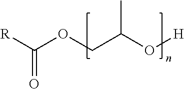
wherein
n is an integer ranging from 3-500, and
R is a C₁-C₂₈ saturated or unsaturated moiety; and
the polypropylene glycol di-ester has the structure: 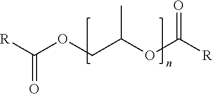
wherein
n is an integer ranging from 3-500, and
each R is independently selected and is a C₁-C₂₈ saturated or unsaturated moiety.

9. The manufacturing process of claim 7, wherein the first component is in the composition in an amount ranging from 250-5000 parts per million, and
the second component is in the composition in an amount ranging from 250-5000 parts per million.

10. A manufacturing process comprising the steps:
compounding a composition having:
a polyolefin,
a first component that is a polyethylene glycol-polypropylene glycol copolymer, a polyethylene glycol-polycaprolactone copolymer, a polypropylene glycol-polycaprolactone copolymer, or a 1,4 butanediol glycol-polycaprolactone copolymer, and
a second component that is a phosphorus-containing compound having one of the following two structures: 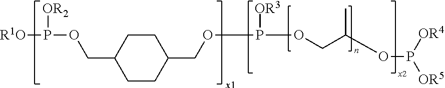
wherein
each R¹, R², R³, R⁴ and R⁵ is independently selected and is a C₁₀-C₁₈ alkyl moiety;
n is an integer ranging from 3-11; and
the sum of x₁+x₂ is an integer ranging from 1-251,
or 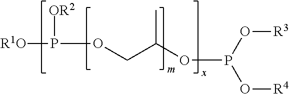
wherein
each R¹, R², R³ and R⁴ is independently selected and is a C₁₀-C₁₈ alkyl moiety;
m is an integer ranging from 3-11; and
x is an integer ranging from 1-122,
wherein the composition does not include a fluorine-containing compound; and
extruding the compounded composition through a die, and
wherein the manufacturing process has a reduced rate of die buildup relative to a manufacturing process that is otherwise the same but does not include the first component or the second component.

11. The manufacturing process of claim 10, wherein the polyethylene glycol-polypropylene glycol copolymer has the structure: 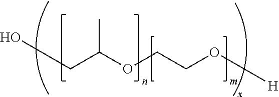
wherein
n is an integer ranging from 1-500,
m is an integer ranging from 1-500, and
x is an integer ranging from 1-500;
the polyethylene glycol-polycaprolactone copolymer has one of the following three structures: 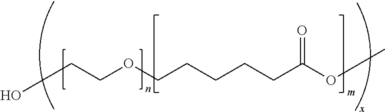
wherein
n is an integer ranging from 1-500,
m is an integer ranging from 1-500, and
x is an integer ranging from 1-500;
or 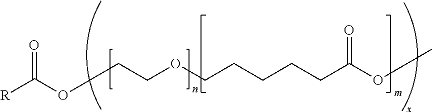
wherein
n is an integer ranging from 1-500,
m is an integer ranging from 1-500,
x is an integer ranging from 1-500, and
R is a C₁-C₂₈ saturated or unsaturated moiety;
or 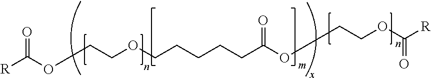
wherein
n is an integer ranging from 1-500,
m is an integer ranging from 1-500,
x is an integer ranging from 1-500, and
each R is independently selected from a C₁-C₂₈ saturated or unsaturated moiety;
the polypropylene glycol-polycaprolactone copolymer has one of the following three structures: 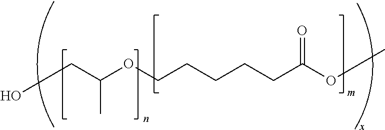
wherein
n is an integer ranging from 1-500,
m is an integer ranging from 1-500, and
x is an integer ranging from 1-500
or 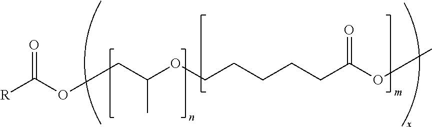
wherein
n is an integer ranging from 1-500,
m is an integer ranging from 1-500,
x is an integer ranging from 1-500, and
R is a C₁-C₂₈ saturated or unsaturated moiety;
or 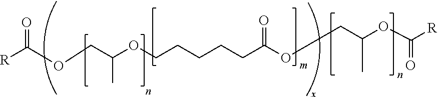
wherein
n is an integer ranging from 1-500,
m is an integer ranging from 1-500,
x is an integer ranging from 1-500, and
each R is independently selected from a C₁-C₂₈ saturated or unsaturated moiety; and
the 1,4 butanediol glycol-polycaprolactone copolymer has one of the following three structures: 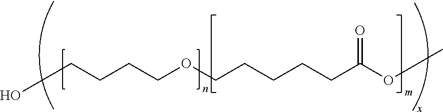
wherein
n is an integer ranging from 1-500,
m is an integer ranging from 1-500,
x is an integer ranging from 1-500
or 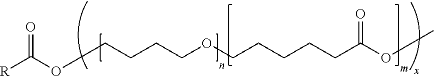
wherein
n is an integer ranging from 1-500,
m is an integer ranging from 1-500,
x is an integer ranging from 1-500, and
R is a C₁-C₂₈ saturated or unsaturated moiety;
or 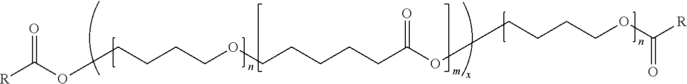
wherein
n is an integer ranging from 1-500,
m is an integer ranging from 1-500,
x is an integer ranging from 1-500, and
R is a C₁-C₂₈ saturated or unsaturated moiety.

12. The manufacturing process of claim 10, wherein the first component is in the composition in an amount ranging from 250-5000 parts per million, and
the second component is in the composition in an amount ranging from 250-5000 parts per million.

13. A manufacturing process comprising the steps:
compounding a composition having:
a polyolefin,
a first component that is an ester prepared from a copolymer of polyethylene glycol and polypropylene glycol, and
a second component that is a phosphorus-containing compound having one of the following two structures: 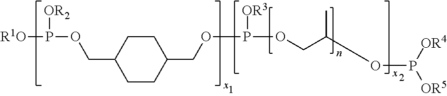
wherein
each R¹, R², R³, R⁴ and R⁵ is independently selected and is a C₁₀-C₁₈ alkyl moiety;
n is an integer ranging from 3-11; and
the sum of x₁+x₂ is an integer ranging from 1-251,
or 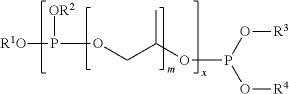
wherein
each R¹, R², R³ and R⁴ is independently selected and is a C₁₀-C₁₈ alkyl moiety;
m is an integer ranging from 3-11; and
x is an integer ranging from 1-122,
wherein the composition does not include a fluorine-containing compound; and
extruding the compounded composition through a die, and
wherein the manufacturing process has a reduced rate of die buildup relative to a manufacturing process that is otherwise the same but does not include the first component or the second component.

14. The manufacturing process of claim 13, wherein the ester prepared from a copolymer of polyethylene glycol and polypropylene glycol has one of the following two structures: 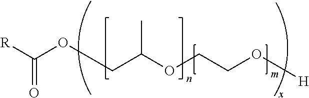
wherein
n is an integer ranging from 1-500,
m is an integer ranging from 1-500,
x is an integer ranging from 0-500, and
R is a C₁-C₂₈ saturated or unsaturated moiety
or 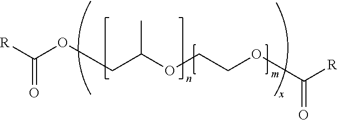
wherein
n is an integer ranging from 1-500,
m is an integer ranging from 1-500,
x is an integer ranging from 0-500, and
each R is independently selected from a C₁-C₂₈ saturated or unsaturated moiety.

15. The manufacturing process of claim 13, wherein the first component is in the composition in an amount ranging from 250-5000 parts per million, and
the second component is in the composition in an amount ranging from 250-5000 parts per million.
